(19) United States
(12) Patent Application Publication
(10) Pub. No.: US 2008/0239968 A1
(43) Pub. Date: Oct. 2, 2008

(54) System and method for gateway call routing

(75) Inventors: Ronald D. Olsen, Lake View, NY (US); Melissa J. Melnik, Colden, NY (US)

Correspondence Address: WEINGARTEN, SCHURGIN, GAGNEBIN & LEBOVICI LLP, TEN POST OFFICE SQUARE, BOSTON, MA, 02109, US

(73) Assignee: Dialogic Corporation

(21) Appl. No.: 12/079,749

(22) Filed: Mar. 28, 2008

Related U.S. Application Data
(60) Provisional application No. 60/920,769, filed on Mar. 29, 2007.

(51) Int. Cl. H04L 12/26; H04M 3/42; H04L 12/28

(52) U.S. Cl. 370/241; 379/201.02; 370/254

(57) ABSTRACT

Methods and apparatus are provided for routing calls or call information. A gateway may span a plurality of networks and determine call routing information based on one or more rules defining a dial plan. Various actions may be taken in response to incoming calls matching rules of the dial plan. User interfaces may be provided that allow editing and/or testing of the dial plan by an administrator.

### CROSS REFERENCE TO RELATED APPLICATIONS

This application claims priority from, and incorporates by reference, the entirety of, currently pending U.S. Provisional Application No. 60/920,769, which was filed Mar. 29, 2007.

### STATEMENT REGARDING FEDERALLY SPONSORED RESEARCH OR DEVELOPMENT

N/A

### BACKGROUND OF THE INVENTION

1. Field

The present disclosure relates to communication gateways, and, more particularly, various aspects of gateways for telecommunications transmissions, including telephone call information.

2. Discussion of Related Art

Upon being placed, a call, including telephone calls, as well as call information associated with the call, is routed through various communication networks. As used herein, the term “call” is meant to refer to any type of telecommunication messaging that can be carried on voice or data or other channels, including for example, video, audio, image, text or signaling information. Accordingly, the term “call” is used herein to indicate any type of information carried over a telecommunication network including networks that operate based on different communication protocols. The term “call information” is used herein to indicate information associated with the call, such as characteristics of the call and/or voice data or signaling information. Call information may travel with the call or over separate signaling channels, for example. Call characteristics may include items such as source or destination identifiers or other information that can assist in processing or routing the call. The call information may also be routed through various communication networks. Traditionally, such communication networks have included specialized telephone provider networks that used a time division multiplexing (TDM), analog or other methods for transmitting voice or data using traditional telephone networks. More recently, communication networks such as the Internet have been used to transport calls and some or all of such call information. For example, technologies such as Voice over Internet Protocol (VoIP) allow users to participate in telephone calls using Internet-based phones that connect through the Internet rather than through traditional telephone networks.

Because of this change in the transportation of telephone call information, calls and some call information may be routed over multiple different communication networks from an original source to a final destination. For example, calls may be made from a VoIP source to a traditional telephone network destination. The call and call information for such a call may be routed from the Internet to a traditional TDM telephone network. A communication gateway may operate at the interface of these two networks to route calls and call information and provide any needed conversions, such as converting from one communication protocol used on one network to another communication protocol used on the other network. Such conversion is well known in the art. To identify routes of information received at such gateways, the gateways may examine certain characteristics of the call and call information, such as the source or destination of the call. Such routing of calls and call information is typically performed in accordance with one or more rules that indicate how a call should be routed based on characteristics of the call. Such a set of rules are referred to herein as a dial plan or as a routing table configuration.

### BRIEF SUMMARY OF THE INVENTION

Prior gateway implementations were provided with limited tools or configurable settings. It is realized that a robust, user-customizable gateway for routing calls and call information, including telephone calls and telephone call information, may allow more and/or improved control over the routing of calls and call information. One or more exemplary aspects of such a gateway provide routing rule configuration, call party identification (CPID) manipulation, error detection, rule testing capabilities, multiple action functionality, routing based on telephony request type and/or a channel pooling feature for grouping communication paths among the same or different interfaces. Telephony request types may include message waiting requests (MWR), voice/data calls or video, as examples. One or more exemplary aspects of the gateway provide a routing table that can be manipulated to determine how a given call is to be routed. Other capabilities of the gateway are also described herein where the gateway provides the user, such as an administrator, with tools to observe gateway operation, change gateway operation or test gateway operation.

One aspect includes a method of testing a dial plan. In one or more aspects, the method comprises providing a dial plan, providing test call information, determining at least one of an action to be performed and forwarding information for the call information based, at least in part, on the dial plan, and transmitting a representation of the at least one of the action to be performed and the forwarding information for the call information. According to an exemplary aspect, there is provided a test interface for composing and implementing a test of a dial plan. The test interface provides simulation of live data with a given configuration of the gateway. For example, the user can provide test data for testing a scenario such as the translation of a destination address through the gateway in accordance with a dial plan or routing table configuration. A test dial plan or test routing table configuration can also be provided through the test interface.

One or more exemplary aspects comprise providing a test interface for providing test scenarios of telecommunications equipment. The test interface permits a user to construct or input information to be processed by the telecommunications equipment, and receive and examine an output of the telecommunications equipment as a result of the processing. The test interface provides the user with a flexible tool for determining if the configuration of the telecommunications equipment is as desired, and that a given input to the telecommunications equipment provides an expected output. One example of an implementation of the test interface permits the user to specify tones to be detected by the telecommunications equipment. The test interface permits the user to apply various tones to the configured telecommunications equipment, such as with an audio file, for example a WAV file, and inspect the operation of the telecommunications equipment to determine if the appropriate tones were detected.

One or more aspects further comprise an act or process of providing the representation through the user interface. In one or more aspects, the user interface includes at least one of a web-based user interface and a console-based user interface. In one or more aspects, the dial plan includes a set of rules that define at least one of when actions should be performed and how to route call information. In one or more aspects, the test call information includes at least one of source information and destination information. In one or more aspects, determining the at least one of the action to be performed and forwarding information for the call information is based, at least in part, on the dial plan and the at least one of the source information and the destination information. One or more aspects include a communication gateway configured to perform a method described above.

One aspect includes a method of processing call information. In one or more aspects, the method comprises receiving an indication of a set of rules, receiving an indication of call information, and determining at least one action from a plurality of available actions to perform in response to receiving the indication of call information based, at least in part, on the set of rules.

In one or more aspects, the call information includes at least one of source information and destination information. In one or more aspects, the act of determining the at least one of the action includes an act of determining the at least one of the action based, at least in part, on the set of rules and the at least one of the source information and the destination information. In one or more aspects, the plurality of available actions includes at least one of blocking a call, logging at least a portion of the call information, raising an alarm, executing a desired program, and notifying a desired entity. One or more aspects include a communication gateway configured to perform a method described above.

One aspect includes a method of grouping communication paths from one or more interfaces. The communication paths, or channels, can be grouped, or pooled, in conjunction with an interface type, such as a TDM interface or a VoIP interface. In addition, communication channels can be grouped by destination points, such as defined by a physical TDM channel or a VoIP host address, for example. In one or more aspects, the method comprises acts of receiving an indication of at least one channel of a first communication interface, receiving an indication of at least one channel of a second communication interface, and grouping the at least one channel of the first communication interface and the at least one channel of the second communication interface into a virtual channel pool.

One or more aspects further comprise acts of receiving an indication of at least one routing rule, the at least one routing rule identifying the virtual channel pool or destination point as a call routing destination, receiving call information matching the at least one routing rule, and routing the call information to the virtual channel pool.

In one or more aspects, the act or process of routing the call information to the virtual channel pool includes acts of determining a one of the at least one channel of the first communication interface and the at least one channel of the second communication interface, and routing the call information to the one of the at least one channel of the first communication interface and the at least one channel of the second communication interface. In one or more aspects, the one of the at least one channel of the first communication interface and the at least one channel of the second communication interface is determined according to a desired selection mode. The communication channel in the channel pool may be a physical TDM channel or a VoIP host address. One or more aspects further comprise an act or process of receiving at least one indication of a desired selection mode. One or more aspects include a communication gateway configured to perform a method described above.

One aspect includes a method of manipulating call information. In one or more aspects the method comprises acts of receiving an indication of a manipulation rule, the manipulation rule identifying a manipulation formula for call information, receiving a representation of a call, such as a telephone call, manipulating information of the call according to the manipulation rule, and routing the call toward a destination of the call.

In one or more aspects, the manipulation formula defines manipulation of non-leading digits of a number identified by the call or call information. In one or more aspects, the number includes at least one of a source identifier and a destination identifier. One or more aspects further comprise an act of defining, using an emancipation rule, an operation performed as an offset to a portion of a number identified by the call information. In one or more aspects, the manipulation formula provides manipulation of a name associated with a call. CPID information can be expressed in terms of characters such as text and/or numbers. Accordingly, the manipulation formula can manipulate call information based on text, numbers or both. One or more aspects include a communication gateway configured to perform a method described above.

One aspect includes a computer-implemented method for editing a dial plan based on input from a user of a computer system, the computer system having a display. In one or more aspects, the method comprises acts of presenting, to the user in the display of the computer system, a user interface, displaying through the user interface a representation of a set of rules, the set of rules defining at least a portion of the dial plan or routing table configuration, accepting from the user an indication of an alteration to an execution of the set of rules, and altering the set of rules to incorporate the alteration.

In one or more aspects, the alteration includes at least one of an enabling of a respective rule of the set of rules, a disabling of a respective rule of the set of rules, and a change to an order of the set of rules. In one or more aspects, the user interface includes at least one of a web-based interface, a windowed application-based interface and a console-based interface. One or more aspects further comprise an act of routing a telephone call using the altered set of rules.

One aspect includes a computer-implemented method for editing a dial plan based on input from a user of a computer system, the computer system having a display. In one or more aspects, the method comprises acts of presenting, to the user in the display of the computer system, a user interface, accepting, from the user, an indication of a desired rule, determining a validity of the desired rule, and displaying, through the user interface, a representation of the validity of the desired rule.

In one or more aspects, the acts of determining and displaying are performed in substantially real-time with respect to the act of accepting. In one or more aspects, the representation includes a colored-coded indicator. In one or more aspects, the user interface includes at least one of a web-based interface, a windowed application-based interface and a console-based interface. In one or more aspects, the act of determining includes determining if a syntax of the desired rule matches a recognized syntax.

Further features and advantages as well as the structure and operation of various aspects are described in detail below with reference to the accompanying drawings. In the drawings, like reference numerals indicate like or functionally similar elements. Additionally, the left-most one or two digits of a reference numeral identify the drawing in which the reference numeral first appears.

### BRIEF DESCRIPTION OF THE DRAWINGS

The accompanying drawings are not intended to be drawn to scale. In the drawings, each identical or nearly identical component that is shown in various figures is represented by a like numeral. For purposes of clarity, not every component may be labeled in every drawing. In the drawings:

FIG. 1 shows an example gateway according to one or more aspects;

FIGS. 2a and 2b respectively show example gateways with call information being received at a VoIP interface for routing to a TDM interface and call information being received at a TDM interface for routing over a VoIP interface in accordance with one or more aspects;

FIGS. 3a and 3b respectively show example gateways receiving a call from a VoIP interface for routing to a TDM interface and receiving a call from a TDM interface for routing over a VoIP interface in accordance with one or more aspects;

FIG. 4 shows an example process that may be performed in accordance with one or more aspects;

FIG. 5 shows an example VoIP table configuration interface in accordance with one or more aspects;

FIG. 6 shows an example TDM table configuration interface in accordance with one or more aspects;

FIG. 7 shows an example channel pool configuration interface in accordance with one or more aspects;

FIG. 8 shows an example VoIP Host Group configuration table;

FIG. 9 shows an example interface through which manipulation rules may be entered in accordance with one or more aspects;

FIG. 10 shows an example interface having an error detected in accordance with one or more aspects;

FIG. 11 shows an example test interface configuration;

FIG. 12 shows an example test dial plan interface in accordance with one or more aspects;

FIG. 13 shows an example test dial plan interface in accordance with one or more aspects;

FIG. 14 shows an example scenario where a gateway may be used to route an incoming TDM call to a different VoIP endpoint based on the calling and called numbers in accordance with one or more aspects;

FIG. 15 shows an example table that may be used with the scenario of FIG. 14 in accordance with one or more aspects; and

FIG. 16 shows an example table that may be used with the scenario of FIG. 14 in accordance with one or more aspects.

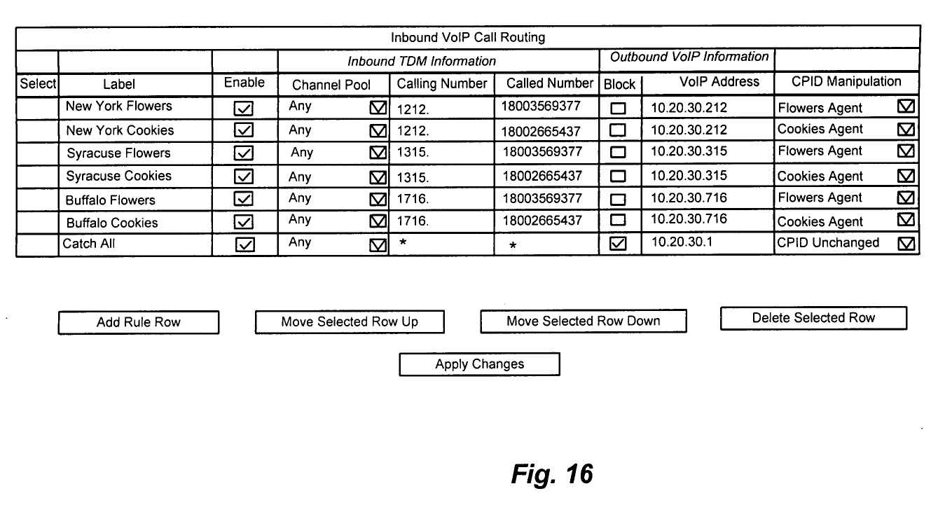

### DETAILED DESCRIPTION OF THE INVENTION

The entire disclosure of U.S. Provisional Application No. 60/920,769, filed Mar. 29, 2007, is hereby incorporated herein by reference.

Embodiments are not limited in their application to the details of construction and the arrangement of components and acts set forth in the following description or shown in the drawings. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

One or more embodiments include methods and/or apparatus for routing calls, including telephone calls, as well as call information, including telephone call information. The call information may also be routed through various communication networks. Call and/or call information may be routed according to a set of routing rules, for example in a routing table, that define a dial plan. The routing rules may define a call routing direction (e.g., a selection of an interface and/or channel) based on one or more desired characteristics of a telephone call. The routing of calls or call information may be performed, at least in part, by a gateway disposed at a border of one communication network with one or more other communication networks.

Such a gateway may include multiple communication interfaces. Each communication interface may connect the gateway to a communication network. In some implementations, multiple interfaces may connect the gateway to a same communication network, for example, to provide redundancy. In other implementations, each interface may connect the gateway to a separate communication network. It should be understood that any type and number of interfaces and communication networks may be used in various embodiments.

In one or more embodiments, an interface between the gateway and a communication network may support multiple communication channels. Such multiple channels may allow separate communication sessions to occur using a single communication interface. Various interfaces may employ any number of communication channels shared according to any sharing scheme (e.g., TDM) in various embodiments. The table below gives some example interface types and a number of interfaces supported and channels supported per interface of example gateways. It should be recognized that the table below is given as a non-limiting example only, and it should be appreciated that other embodiments may include any number and type of interfaces having any number of channels.

| | Example number of | Example number of supported |
|---|---|---|
| Example Type | supported Interfaces | Channels per interface |
| Analog | 8 | 1 |
| Digital (PBX) | 8 | 1 |
| T1-CAS | 4 | 24 |
| T1-ISDN | 4 | 23 |
| E1 | 4 | 30 |

One or more embodiments may include an ability to test the routing of call information. In some implementations, such testing may be performed with simulated calls or call information without routing live calls or live call information, such as after a gateway or router is configured and before the gateway or router is installed, enabled, or reconfigured to handle live traffic. Such functionality may be useful for determining if a dial plan of a gateway is working properly (e.g., as an administrator desires) before the gateway is put into operation.

One or more embodiments may allow communication paths or channels of one or more communication interfaces to be grouped together into a communication path group or channel pool. Such a channel pool may then be used to route calls or call information with a common characteristic. For example, a dial plan may indicate that call information having desired characteristics be routed to a desired channel pool. The call information may then be routed to an available channel in the channel pool. The channel pool may include channels from more than one communication interface, such as one set of channels on a first TDM interface and one set of channels on a second TDM interface or other type of interface. By way of example, the channel pool may constitute a mixed destination group that includes one or more channels from a TDM interface and/or one or more VoIP interfaces. By allowing grouping of channels over multiple interfaces, routing to such a channel pool may include redundancy so that even if one interface fails or is occupied, the second interface may still operate or be available, thereby allowing call information to be routed properly. Channel pooling permits the application of a definition to a channel to include or exclude channels in relation to a given grouping. For example, specific channels can be reserved for emergency use.

One or more embodiments may provide functionality to alter calls or call information in a robust manner. In some implementations, altering calls or call information may include altering call characteristics according to a desired algorithm established by a user (e.g., an administrator). For example, a call may be received at a gateway having a source number of “3456789.” This characteristic of the call may be altered to “John's Phone” when the call is routed by the gateway. When the call is received at a destination, a caller identification system may display “John's Phone” as a source of the call rather than the number “3456789.” Other examples are given below.

One or more embodiments may provide an ability to perform one or more actions in addition to or as an alternative to routing and altering in accordance with one or more rules. For example, a call may be blocked or logged, a desired individual may be contacted when a call is received (e.g., call or otherwise notify the police if a harassing caller makes a call) and/or any other action may be taken when a call having desired characteristics is received. Such actions may provide an administrator of a gateway more flexibility to control calls going through the gateway, such as monitoring those calls to improve future routing and preventing unwanted calls from passing through the gateway.

One or more embodiments may include a user interface through which a user (e.g., an administrator) may access information regarding a dial plan or gateway configuration, including routing table configuration. Through such a user interface, a user may develop and/or edit a dial plan, including rules for actions to be performed based on characteristics of received calls, and/or test a dial plan, as mentioned above and described further below. In one or more embodiments, such a user interface may include a web-based interface, a console interface, and/or any other interface desired.

In one or more embodiments, a user interface may provide the ability to alter an execution of a dial plan (e.g., make new rules and delete old rules) as mentioned above. Such functionality may include the ability to enable and disable specific rules of the dial plan. This may allow a user to temporarily disable or enable special purpose rules, for example, a rule that is only desired for a particular period of time. In one or more embodiments, the interface may allow a user to reorder the application order of rules without deleting and/or creating new rules. This may allow a user to reestablish the priority of rules without recreating the entire set of rules making up a dial plan.

In one or more embodiments, the user interface may provide rule validation functionality. In some implementations, such functionality may include substantially real time rule validation. Rule validation may provide a user developing a one or more rules with information regarding the validity (e.g., correct syntax) of the rule. Some implementations may validate syntax of a rule by matching the syntax to a recognized syntax. Such validation may allow a user to debug rules during the development of a dial plan.

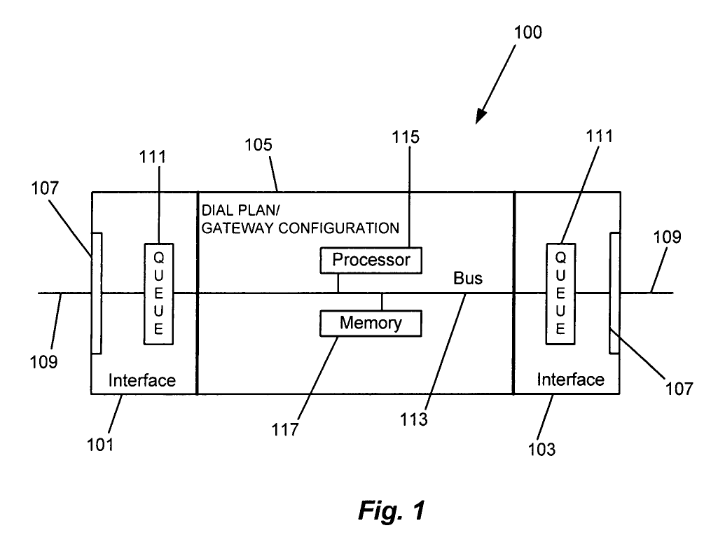

FIG. 1 shows an example gateway 100 according to one or more embodiments. By way of example, and as depicted and described herein, a “gateway” can be a media gateway, such as a gateway from the Dialogic 1000 Media Gateway series or the Dialogic 2000 Media Gateway series, which are commercially available from Dialogic Corporation of Montreal, Quebec, Canada. As shown, gateway 100 may include a first communication interface 101, a second communication interface 103, and a dial plan section 105. Dial plan section 105 represents a configuration of gateway 100 for processing calls or call information. Calls or call information, including telephone call information, may be received by one of the first and second communication interfaces and forwarded to dial plan section 105. Dial plan section 105 may determine what actions, if any, should be taken based on received call information. The call information may, in at least some circumstances, be routed on one of the first and second communication interfaces. It should be understood that gateway 100 is given as an example only and that any number of interfaces and any configuration of a gateway may be used in various embodiments.

As shown, communication interfaces 101, 103 may each include a connection port, each labeled at 107. Connection ports 107 may allow a physical connection between a communication link, each labeled at 109 (e.g., an Ethernet cable) and communication interfaces 101, 103. In some implementations, each communication interface 101, 103 may include a queue element, such as a stack, each indicated at 111. Queue elements 111 may store received information until dial plan section 105 is ready to process the information and/or may store processed information until the respective communication interface 101, 103 is available to transmit the information. In some implementations, elements of the respective communication interfaces 101, 103 and dial plan section 105 may be connected by one or more buses 113.

Dial plan section 105, as shown, may include a processing element 115. In some implementations, processing element 115 may include a microprocessor, application specific integrated circuit, or like device. In some implementations, processing element 115 may include an IXP465 processor available from Intel Corporation. Dial plan section 105 may include a memory element 117. Memory element 117 may store instructions, rules, and/or data for processing information. In some implementations, memory element 117 may include RAM, ROM, a hard disk, and/or any other desired memory device. In one or more embodiments, memory element 117 and processing element 115 may be connected to communication interfaces 101, 103 and/or any other elements of dial plan section 105 through bus 113.

In one or more embodiments, dial plan section 105 may match received call information from a respective communication interface with one or more rules that define a dial plan. Dial plan section 105 may then facilitate the performance of a desired action or lack of action based on a matched rule or rules. For example, dial plan section 105 may forward information on a desired communication interface, block information, and/or perform any other desired action, as described in more detail below. In some implementations, such actions may be performed by executing one or more machine instructions (e.g., instruction stored in memory element 117 and executed by processing element 115). In some implementations, one or more actions may be performed in combination with one or more other computing devices, such as a general purpose computing device. Such other computing devices may be connected to gateway 100 through a communication network (e.g., through one of communication interfaces 101, 103 or through a separate communication network (not shown)).

In one or more embodiments, some rules of a dial plan may define how to route call information based on one or more call characteristics. Such characteristics may include a destination address and/or call party identification (CPID) information as well as any other desired characteristics.

In some implementations, communication interface 101 may include an interface for VoIP or other internet based communication, and communication interface 103 may include an interface for TDM communication, such as communication over a T1, E1, analog, or other telephone communication line. In such implementations, the dial plan can operate on calls originating from the VoIP side, and/or calls originating from the TDM side.

It should be recognized that embodiments are not limited to having such differing interfaces or to two interfaces and that in one or more embodiments, a gateway may include two or more similar interfaces and/or any number of different types of interfaces. The non-limiting example below is described in terms of a gateway having a VoIP interface and a TDM interface.

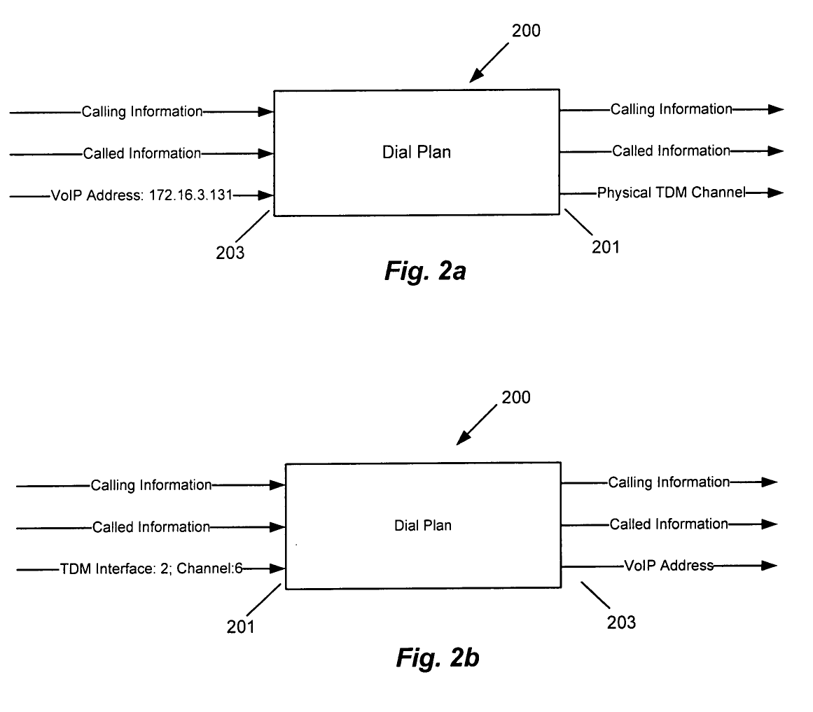

FIGS. 2a and 2b illustrate operation of a gateway or router in a general case for routing calls and call information between a TDM interface and a VoIP interface. In FIG. 2a a gateway 200 is illustrated as having a VoIP interface for receiving calls and call information, and providing routing to a TDM interface 201. In FIG. 2b, gateway 200 is illustrated as having a TDM interface 201 receiving calls and call information for routing to VoIP interface 203. The term “call” is used to indicate any type of information carried over a telecommunication network, including networks that operate based on different communication protocols. The content of the call is sometimes referred to as bearer information. The term “call information” is used to indicate information associated with the call, such as characteristics of the call and/or voice data or signaling information. In FIGS. 2a and 2b, the calling information and called information applied to and provided by gateway 200 is generally in the form of alphanumeric characters, including text representations of names and numbers or other types of representations such as, for example, providing a digit code to represent numbers. Gateway 200 operates on the calling information and called information to perform routing functions. For example, gateway 200 may identify or match a name or number in accordance with a routing rule to determine how a call from VoIP interface 203 should be routed through TDM interface 201. Similarly, in FIG. 2b, gateway 200 may identify a name or number in a call or call information applied to TDM interface 201 to determine how the call should be routed to VoIP interface 203.

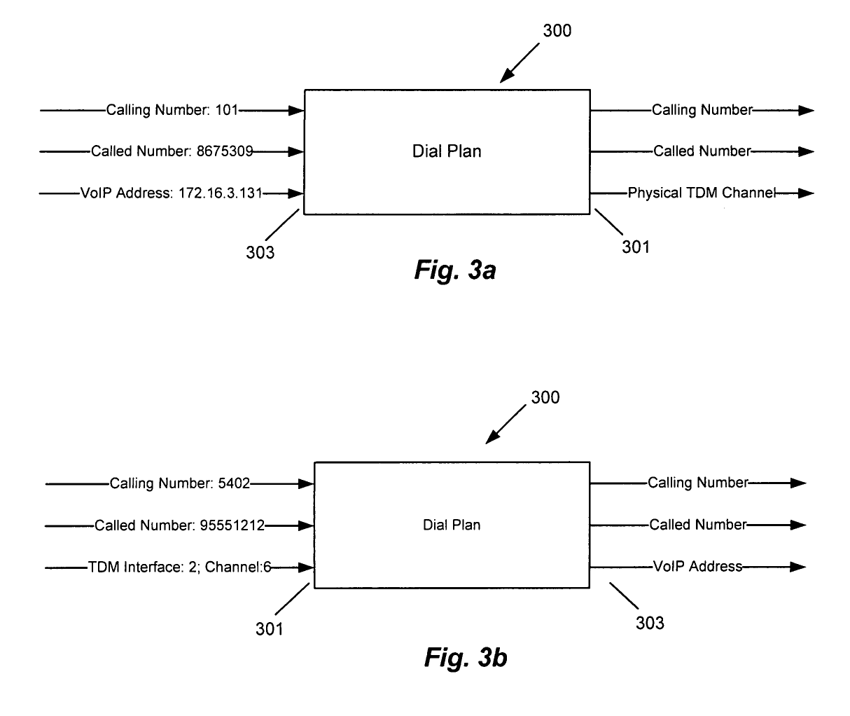

FIG. 3a shows an example gateway 300 having a TDM interface 301 and a VoIP interface 303. Example gateway 300 is shown with call information being received at VoIP interface 303 for routing to TDM interface 301 in FIG. 3a. In one or more embodiments, calls received by VoIP interface 303 of gateway 300 may have two associated URLs (Uniform Resource Locators). One URL may include the originating address and a calling number. The other URL may include a destination address and/or a called number. The dial plan may use these characteristics and/or any other desired information to determine a TDM destination for the call. For example, a call having a URL identifying a source number as 101@1172.16.3.131 and a URL having a destination number as 8675309@172.16.3.200, as shown in FIG. 3a, may be received by gateway 300. Such a call may correspond to the user at address 172.16.2.131 attempting to connect to gateway 300 at address 172.16.3.200. The information may correspond to a calling number of 101 and a called number of 8675309. Gateway 300 may determine how to route the call to the destination and/or determine whether to perform any other desired actions based on the dial plan maintained by gateway 300.

FIG. 3b shows example gateway 300 receiving a call from TDM interface 301 for routing over VoIP interface 303. Calls received at TDM interface 301 may include information such as a physical source, along with calling and called number information. In one or more embodiments, the dial plan may use any combination of the physical source, calling, called numbers and/or any other information to determine a URL of the destination of the call. For example, as shown in FIG. 3b, a call may be received by TDM interface 301 on channel 6 from calling number 5402 to called number 95551212. The dial plan may be referenced to determine how to route this received call to the destination and/or whether to perform any other desired actions, as described in more detail below.

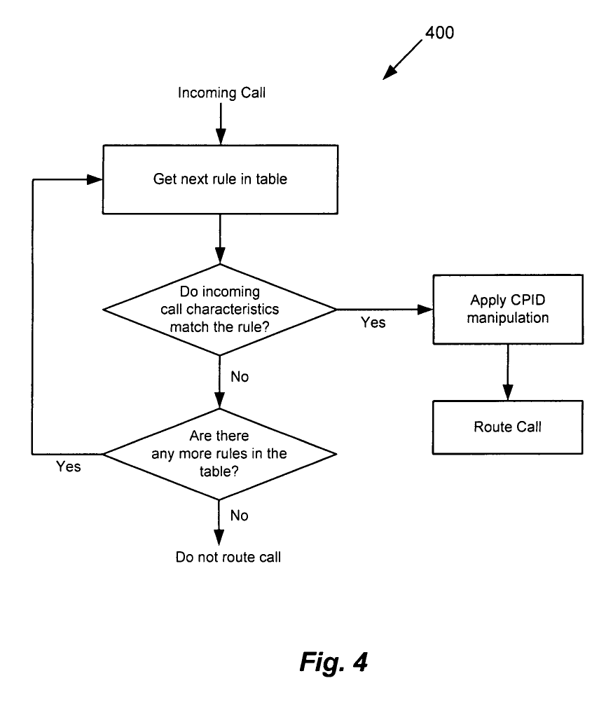

FIG. 4 shows an example process 400 that may be performed in accordance with one or more embodiments to match received call information to one or more rules of a dial plan. In one or more embodiments, process 400 may be performed by a gateway (e.g., 100, 200). As indicated in FIG. 4, a call may be received (e.g., by a gateway), and a next rule may be retrieved from a rule storage (e.g., a database or routing table). One or more characteristics of the call may be matched against the next rule. If the characteristics do not match, successive rules may be retrieved until a match is found or rules are exhausted. If a match is found, the call characteristics may be altered/updated based on manipulation rules assigned to the matched rule and/or other actions may be taken based on actions associated with the matched rule. The call may be routed to the destination in accordance with the matched rule. If no match is found, the call may not be routed by the gateway.

In one or more embodiments, matching of names or numbers identifying a source or destination may be used as a criterion for matching an incoming call to a rule. For example, an incoming calling or called number may be tested against one or more rules in a desired order. The rules may be entered into a user interface which is described below, by, for example, an administrator. The rules may be stored in one or more tables (e.g., database or routing tables stored in memory element 115) that may be accessed to test for matches (e.g., by processing element 113).

The table below shows an example syntax that may be used in one or more embodiments to match/define incoming numbers and/or rules. The example shows an attempted match with the following number: 7168675309.

| | | | Example |
|---|---|---|---|
| Token | Description | Example Rule | Result |
| 0 1 2 3 4 | Digit | 7168675309 | Match |
| 5 6 7 8 9 | | 7168675308 | No Match |
| Digit string, | Match any single or | 716[3,810-900]5309 | Match |
| Digit string- | range of digits | 716[3,870-900]5309 | No Match |
| digit string | | | |
| X | Match any single digit | 716xxx5309 | Match |
| | | 716xxxx5309 | No Match |
| · | Match any number of | x16. | Match |
| | ending digits | x15. | No Match |
| * | Match any number of | Same as ‘.’ above | |
| | ending digits | | |

In one or more embodiments, a gateway may maintain separate rule sets for each communication interface and/or each type of communication interface. For example, gateway 200 of FIGS. 2-4, which spans two communication networks (e.g., TDM and VoIP networks) may maintain two separate sets of rules. Such sets may be maintained for example in one or more database tables.

In the example embodiment, a VoIP table may be maintained for incoming calls from the VoIP network. When a call is received from the VoIP network, the incoming call characteristics may be compared against the values in the VoIP rule in the first row of the table. If a match is found, an associated action may be taken. If no match is found, the next row in the table may be checked. Rows may be tested successively until a match is found, or there are no more entries in the table.

In some implementations, a call may match if some or all of the VoIP address, calling name, calling number, called name and called number of the rule match the incoming call. Once a match occurs, the call information may be modified and/or other actions may be taken before or as an alternative to routing a call. Next, the outgoing call may be routed out the TDM interface using a channel pool or specific channel identified by a rule. It should be understood that other interfaces may be used and that the call may not be routed at all or may be routed on the VoIP interface rather than the TDM interface. For example, if no rows in the table successfully match the incoming call, the call may not be routed at all.

In some implementations, one or more interfaces and/or database or routing tables may be used to store rules. In one example implementation, a gateway may provide four configuration interfaces (e.g., incoming TDM call routing, incoming VoIP call routing, CPID manipulation and channel pool) and a test interface, each of which is described herein. A dial plan may use information from the four configuration interfaces to determine routing information, actions to be taken, and/or perform testing. Each example interface is described below. It should be recognized that embodiments are not limited to the number or configuration of interfaces described.

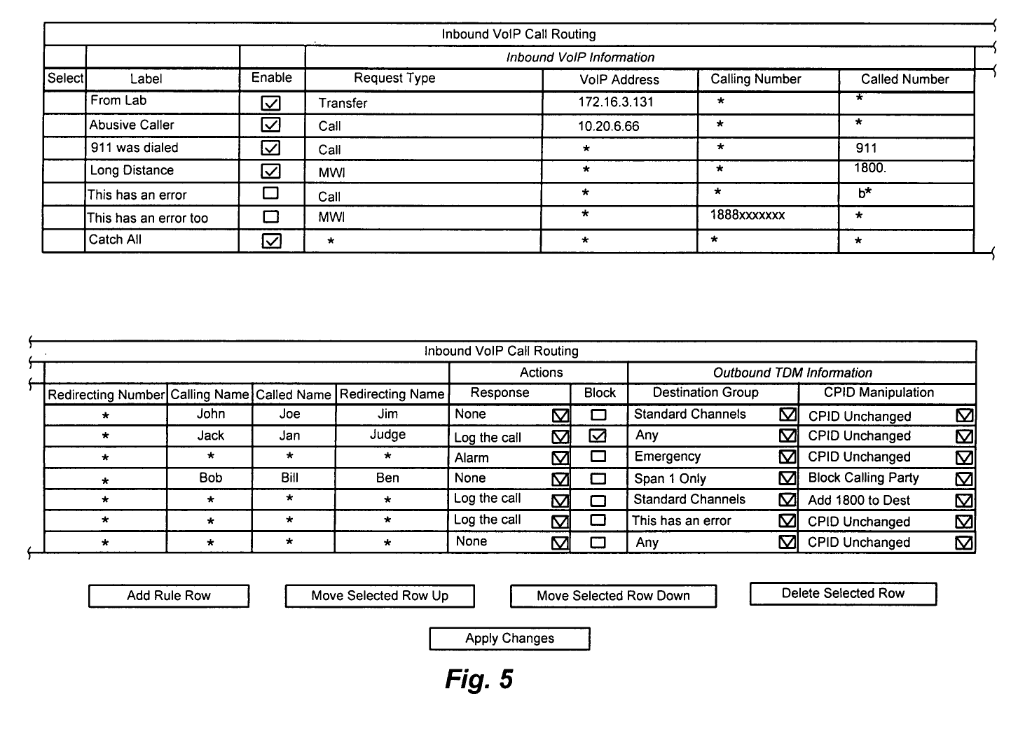

FIG. 5 shows an example VoIP table configuration interface that may be used to establish rules for incoming VoIP calls of the example embodiments. The example interface includes the following controls:
Select—Click to select a row. A selected row may be moved up or down in the table, and/or deleted in one or more embodiments.
Label—Label for this entry. This label may be used to help identify the rule to the administrator. In one or more embodiments, the label may be unique.
Enable—Check this box to enable the rule. If this box is not checked, this rule may not be matched for incoming calls.
Request Type—Matched against the type of incoming request. This could be a call or a message (or another form of media). Some examples of request types are call, MWI, transfer, video, text messaging, as well as any other type of message or communication regardless of protocol.
Host—The string to match the VoIP address of the incoming call. In some implementations, this value may be an IP address in the form xxx.xxx.xxx.xxx to match a specific address, a ‘*’ to match any IP address, a name or any other identifier for a host site on a network and/or any other desired value.
Calling Number—The string to match the calling number of the incoming call.
Called Number—The string to match the called number (dialed number) of the incoming call.
Redirecting Number—The string to match the redirecting number of the incoming call.
Calling Name—The string to match the calling number name of the incoming call.
Called Name—The string to match the called number name (dialed number) of the incoming call.
Redirecting Name—The string to match the redirecting name of the incoming call.
Block—If this box is checked for a matched rule, the incoming call may be blocked if the rule is matched. In some implementations, no outgoing call may be made in such circumstances and no more rules in the table may be tested.
Destination Group—The label of an entry in the “Destination Group” table, described below, used to specify the physical interface and channel of the outgoing call.
CPID Manipulation—The label of an entry in the “CPID Manipulation” table, described below, used to create the calling, called and redirected name and number of the outgoing call.

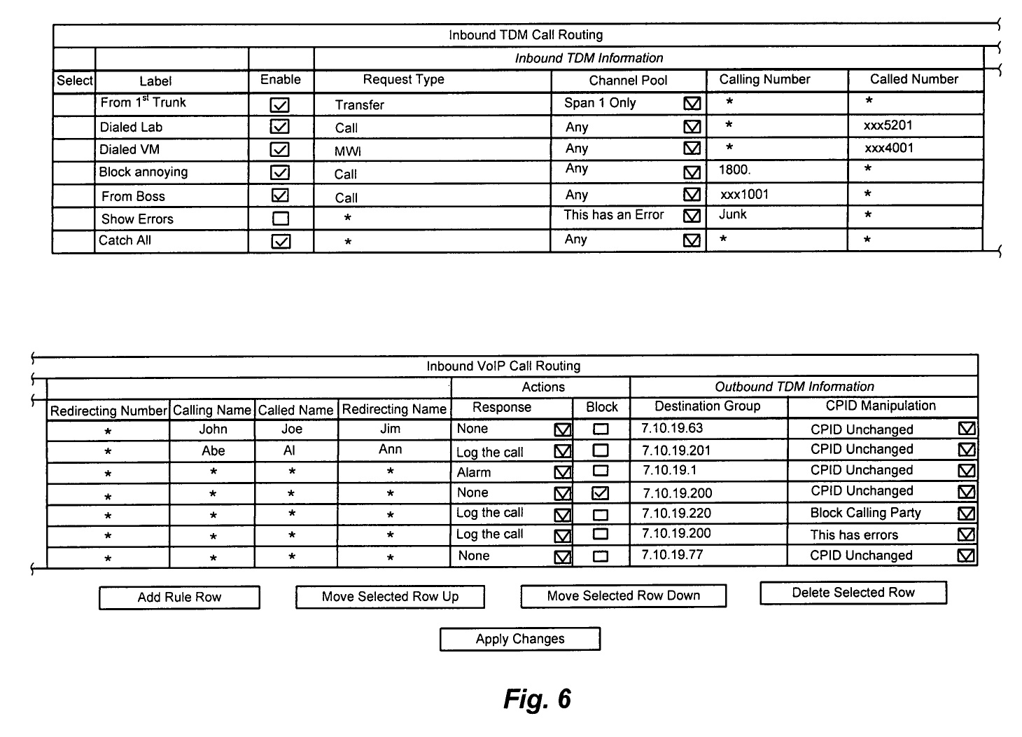

FIG. 6 shows an example TDM routing table configuration interface. The example interface may be used to establish and maintain rules for calls received from a TDM network. When a call is received, the incoming call characteristics may be compared against the values entered in the first row of the table. If a match is found, an action may be taken. If no match is found, the next row in the table may be checked. Rows may be tested successively until a match is found, or there are no more entries in the table, similar to the treatment for receipt of a call from the VoIP interface described above.

In some implementations, a rule may match the call or call information if the channel of the incoming call resides in the specified channel pool or destination group, the calling number matches the rule, the called number match the rules, and/or any other desired characteristics match the rule entered in the table. Once a match occurs, the call or call information may be modified and/or other actions may be taken before or as an alternative to routing a call. Next, the outgoing call may be routed out the VoIP interface to the address specified. It should be understood that other interfaces may be used and that the call may not be routed at all or may be routed on the TDM interface rather than the VoIP interface. For example, if no rows in the table successfully match the incoming call, the call may not be routed at all.

The example configuration interface includes the following controls:
Select—Click in this column to select a row. A selected row may be moved up or down in the table, and/or deleted in one or more embodiments.
Label—Label for this entry. This label may be used to help identify the rule to the administrator. The label may be unique in one or more embodiments.
Enable—Check this box to enable the rule. If this box is not checked, this rule may not be matched to incoming calls.
Request Type—Matched against the type of incoming request. This could be a call or a message (or another form of media). Some examples of request types are call, MWI, transfer, video, text messaging, as well as any other type of message or communication regardless of protocol.
Channel Pool—The label of an entry in the “Channel Pool” table, which is discussed below, used to specify the physical interface on which the incoming call may reside.
Calling Number—The string to match the calling number of the incoming call (e.g., the “To” field of the URL).
Called Number—The string to match the called number of the incoming call (e.g., the “From” field of the URL).
Redirecting Number—The string to match the redirecting number of the incoming call.
Calling Name—The string to match the calling name of the incoming call (e.g., the “To” field of the URL).
Called Name—The string to match the called name of the incoming call (e.g., the “From” field of the URL).
Redirecting Name—The string to match the redirecting name of the incoming call.
Block—If this box is checked for a matched rule, the incoming call may be blocked. In some implementations, no outgoing call may be made and no more rules in the table may be tested.
Destination Group—The label of an entry in the destination group table, used to specify the physical interface and channel of the outgoing TDM call or VoIP destination address.
CPID Manipulation—The label of an entry in the “CPID Manipulation” table, which is discussed below, used to create calling, called and redirected name and number of the outgoing call.

In some implementations, one or more of the inbound VoIP call configuration interface and the inbound TDM call configuration interface or a like interface may include additional action functionality. For example, in some implementations, when a call matching a defined rule is received, a desired action may be taken. In some implementations, such an action may include, for example, executing a desired program, logging call information (e.g., logging that the call took place, logging a duration of the call, etc. in memory element 115 or a remote storage location), raising an alarm or warning, notifying a desired individual (e.g., the police when a harasser calls), and/or any other desired action. In such implementations, the interfaces may include a control to enter such desired action information.

Further, formulas for matching call characteristics to a call routing rule may be entered via the dial plan configuration in the Inbound VoIP Call configuration interface and/or the inbound TDM call configuration interface. It should be recognized that these call configuration interfaces are given as non-limiting examples, and that other implementations may have other interfaces and/or a single universal call or gateway configuration interface.

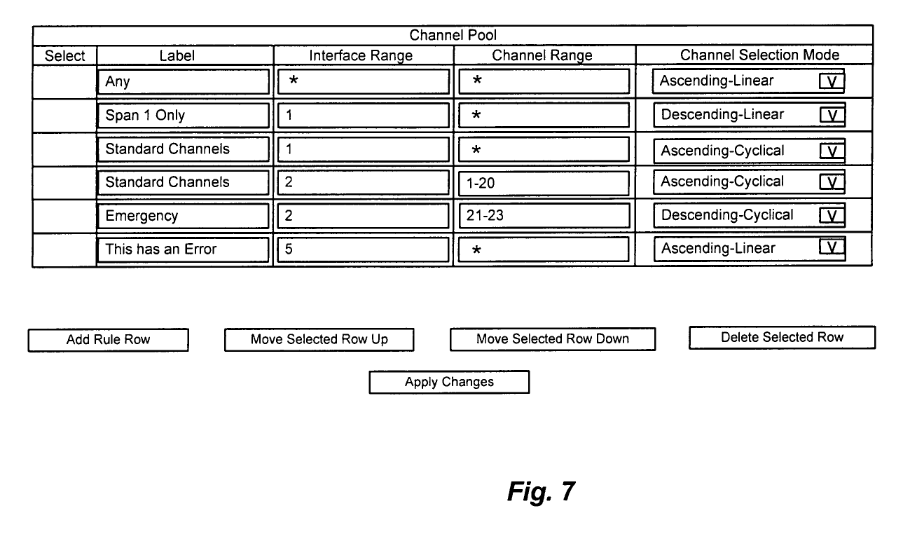

As mentioned above, one or more embodiments may allow a user to establish channel pools. FIG. 7 shows an example channel pool configuration interface that may be used by to establish channel pools in one or more embodiments. The example channel pool configuration interface includes the following controls:
Select—Click in this column to select a row. A selected row may be moved up or down in the table, and/or deleted in one or more embodiments.
Label—Label for this entry. This label may be referenced in the “Inbound VoIP Routing” and/or the “Inbound TDM Routing” configuration pages to select a particular channel pool defined in this interface.
Interface Range—The physical interface(s) assigned to this channel pool. In some implementations, numbers can be entered in the form #,# to select individual interfaces, or #-# to select a range of interfaces, or a combination of both. For example, 2,5-7 would use interfaces 2, 5, 6, and 7. The ‘*’ character may represent all available interfaces.
Channel Range—The logical channel(s) within the interface(s) assigned to this channel pool. In some implementations, numbers can be entered in the form #,# to select individual channels, or #-# to select a range of channels, or a combination of both. For example, 2,5-7 would use channels 2, 5, 6, and 7. The ‘*’ character may represent all available channels.
Channel Selection Mode—The channel selection mode used for outgoing TDM or VoIP calls and/or other desired calls. Defines a desired method of selecting channels with a channel pool.

Information entered in the channel pool configuration interface may be used to generate a channel pool database table. This information may create one or more logical groupings of interfaces and channels. A channel pool is a way of identifying a set of interface/channel combinations. For some calls, it may be desirable to select a specific interface and channel from a group of possible options. A channel pool may define how this is selected. In one or more embodiments, a user may define a channel pool to include channels from a plurality of interfaces and/or interface types. A channel pool spanning multiple interfaces may be useful to provide redundancy to a gateway. For example, channels on multiple interfaces may be grouped into a channel pool associated with emergency calls. When a call to 911 or another emergency number is received, any interface grouped into the channel pool may be used to route the call. As long as any single interface remains in operation, such a call may still be routed properly.

In one or more embodiments, a user may select a method for choosing which channel within a channel pool is used to place an outgoing call. The channel pool configuration may use a channel selection mode configuration option to allow a user to select this option. In some implementations, such options may include, as non-limiting examples:
Ascending Linear—The first (lowest logical) channel is chosen to place the call.
Ascending Cyclical—Channels are chosen upward sequentially from call to call. The selection wraps back to the first channel when the limit is reached.
Descending Linear—The last (highest logical) channel is chosen to place the call.
Descending Cyclical—Channels are chosen downward sequentially from call to call. The selection wraps back to the last channel when the limit is reached.

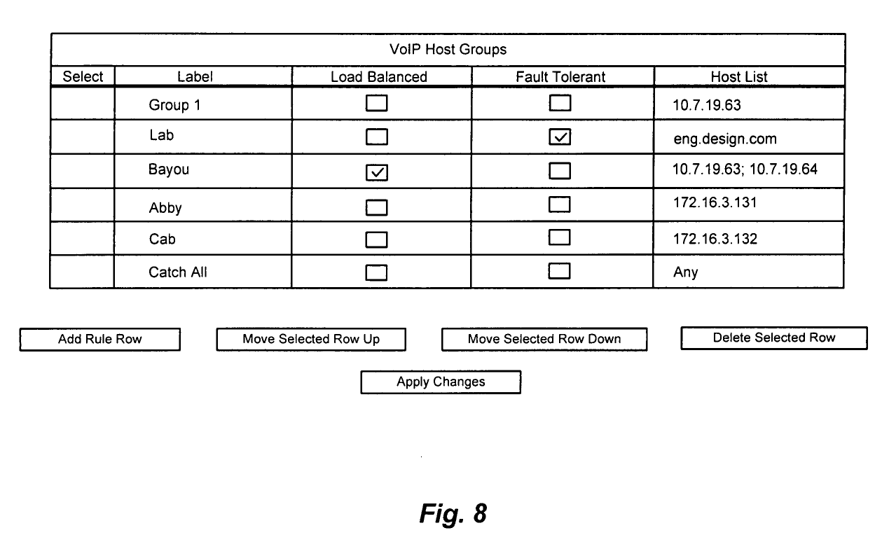

One or more embodiments may allow a user to establish VoIP host groups. A VoIP host group is a set of host addresses, and may have zero or more entries. The entries may include URIs. FIG. 8 shows an example VoIP host group configuration interface that may be used to establish VoIP host groups in one or more embodiments. The example VoIP host group configuration interface includes the following controls:
Select—Click in this column to select a row. A selected row may be moved up or down in the table, and/or deleted in one or more embodiments.
Label—Label for this entry. This label may be referenced in the “Inbound VoIP Routing” and/or the “Inbound TDM Routing” configuration pages to select a particular VoIP host group.
Load Balanced—If enabled, the gateway will route related outbound VoIP requests to the next member within this group in a round-robin fashion. If this feature is disabled, requests will be processed linearly.
Fault Tolerant—If enabled, the gateway will use the next member in the list if the previous attempt to route the VoIP request fails. If this feature is not enabled, the request will fail to be routed if not successful after the initial attempt.
Host List—Includes all URIs (Uniform Resource Identifiers) belonging to the group.

Information entered in the VoIP host group configuration interface may be used to generate a VoIP host group database table. The information may be used to create one or more logical groupings of VoIP hosts. A VoIP host group is a way of identifying a set of VoIP hosts or VoIP host combinations.

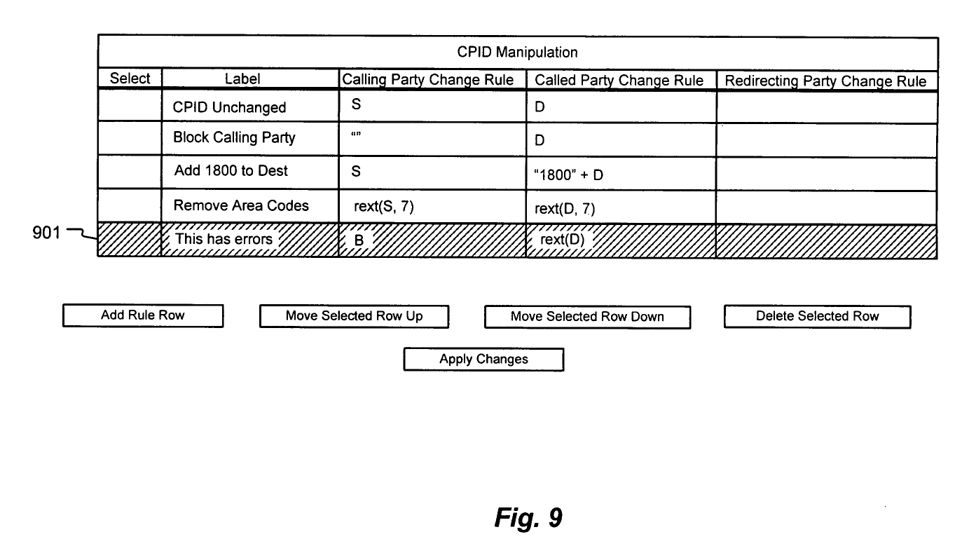

As mentioned above, in one or more embodiments call information may be altered or manipulated by a gateway before routing. FIG. 9 shows an example interface through which number manipulation rules may be entered by a user. Rules may also be provided for name manipulations, as well as for manipulating any other type of call information or control or signaling information for a call. Information entered through this interface may be stored in one or more database tables. When a rule is matched from an incoming call table, as described above, the manipulation defined by the rule, if any, may take place before the call is routed in accordance with the rule. Some rules may apply a formula using the incoming call information as input to determine the outgoing call information. In one or more embodiments, the formula used may manipulate any portion of a call information variable, including, but not limited to, non-leading digits of a variable.

The example interface includes the following controls:
Select—Click in this column to select a row. A selected row may be moved up or down in the table and/or deleted in one or more embodiments.
Label—Label for this entry. This label may be referenced in inbound routing tables to reference manipulation rules.
Calling Party Change Rule—The formula that determines the calling party name or number of the outgoing call.
Called Party Change Rule—The formula that determines the called party name or number of the outgoing call.
Redirecting Party Change Rule—The formula that determines the redirecting party name or number of the outgoing call.

The following table shows an example syntax that may be used to define rules in one or more embodiments. The example refers to an incoming VoIP call: From: 7168675309@172.16.3.15 To: 5551212@10.20.34.78 in which matching is performed on numbers. Like syntax and rule definitions may be applied to name matching rules, for example.

| | | Example | Example |
|---|---|---|---|
| Rule Syntax | Description | Rule | Result |
| S | Source (calling) number | S | 7168675309 |
| D | Destination (called) number | D | 5551212 |
| R | Redirection number | R | |
| I | Inbound VoIP address | I | 172.16.3.15 |
| “” | Takes what's in quotes as | “353” | 353 |
| | literal | | |
| + | Concatenate | “800” + D | 8005551212 |
| lext(str, n) | Extract n characters from left | lext(S, 3) | 716 |
| | of str | | |
| rext(str, n) | Extract n characters from | rext(S, 4) | 5309 |
| | right of str | | |
| lrem(str, n) | Remove n characters from | lrem(S, 3) | 8675309 |
| | left of str | | |
| rrem(str, n) | Remove n characters from | rrem(D, 4) | 555 |
| | right of str | | |
| mext(str, | Extract n characters from str | mext(S, 5, 2) | 53 |
| pos, n) | starting pos digits from left | | |
| repl(str, | Find 1^{st} occurrence of old in | repl(D, “12”, | 5554612 |
| old, new) | str and replace with new | “46”) | |

In one or more embodiments, some or all of the above described configuration interfaces may include certain interface controls. To add a rule, for example, a user may select an “Add Rule Row” control. A rule with default values may be placed at the bottom of the table. A user may edit values of this rule to define a desired rule. To edit a rule, a user may select a field and enter information into the field. To delete a rule, a user may click the row on the left side in the “select” area. The background of the row may change color or otherwise indicate selection has been made. Once the row has been selected, a user may select a “Delete Selected Row” control to delete the row.

In some implementations, as described above, rules may be matched from top to bottom. It may be desired to alter the order of rules to improve performance of rule matching. In some implementations, to do this, a user may select a row, and then select a “Move Selected Row” control (e.g., a move row down or a move row up control).

In some implementations, a user may save changes made through a configuration interface by selecting an “Apply Changes” control. In some implementations, by selecting this control, an indication of rules and/or changes to rules may be transmitted to a gateway/received by a gateway thereby updating a dial plan. In some implementations, an indication of channels of communication interfaces making up a channel pool may be transmitted to/received by a gateway when such a control is selected.

In one or more embodiments, one or more of the configuration interfaces may include an error detection feature. Such a feature may be used, for example, to determine if an entered rule includes recognized syntax. In some implementations, for example, a rule may be parsed to determine if the rule is recognized by a gateway. If the rule is not recognized then, an indication may be given to the user that the rule includes an error. In some implementations, such an indication may include a colored background (e.g., yellow or red). In some implementations, a specific portion of a rule that is not recognized may be indicated in addition to or as an alternative to indicating the rule as a whole. Rules with an error anywhere in the row may be treated as disabled, and may not be processed. In some implementations, error detection may occur substantially in real time. For example, error detection may occur while a rule is being entered (e.g., after each field is filed out and/or while the field is being filed out). In other implementations, an error detection control may be selected to perform the error detection.

In some implementations, as shown in FIG. 9, if a table entry is highlighted (e.g., in red) there may be an error in that entry. In the case of the highlighted rule of an entry 901 in the table of FIG. 9, the ‘B’ is not a valid called number match rule.

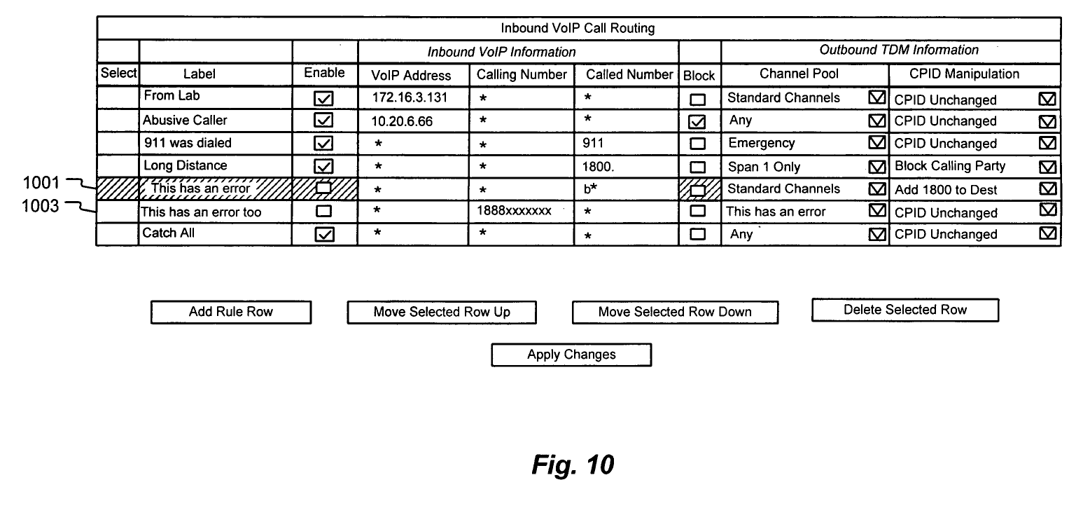

In some implementations, as shown in FIG. 10, if a table entry is highlighted (e.g., in yellow), there may be an error in the rule that the entry references. In the example of FIG. 10, there is an error in a channel pool table entry 1001 that has the label ‘This has an error’ because the called number is erroneously listed as b*. However, there is also an error in an entry 1003 labeled “This has an error too” because the referenced channel pool “this has an error” has an error. The two types of direct and indirect errors may be differently indicated.

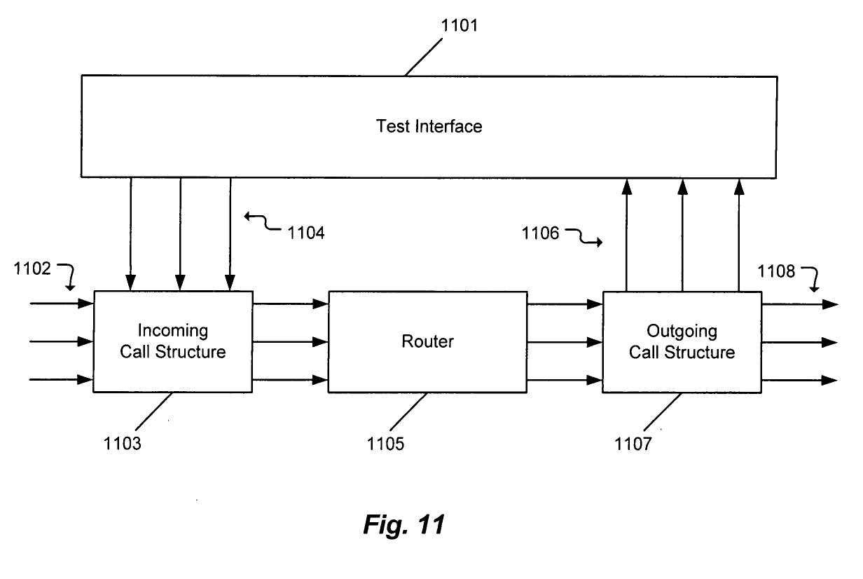

In one or more embodiments, as shown in FIG. 11, a test interface 1101 is provided. Test interface 1101 is used to generate test data that can be applied to a telecommunication device to determine how the telecommunication device responds to the test input. The response by the telecommunication device can be used to determine if the telecommunication device is configured or operating properly.

In the example embodiment of FIG. 11, a router 1105 is used as the telecommunication device. Other examples of telecommunication devices that may be used with test interface 1101 include gateways, tone detectors, CAS signaling devices (described below), as well as any other type of telecommunication device to which test interface 1101 can be coupled.

Test interface 1101 in FIG. 11 operates by preventing a user to enter, generate, select or otherwise construct data to be applied to router 1105. The desired data is provided in a data structure that is delivered into an incoming call structure 1103, which is a mechanism for applying data to router 1105. Call structure 1103 ordinarily operates to deliver data to router 1105 in a particular format that includes a data structure organized to be used by router 1105 in routing calls. Router 1105 manipulates or otherwise routes a call or call information in accordance with the content of the call information and rules configured within router 1105, as discussed above. The manipulated or routed call or call information is delivered to an outgoing call structure 1107 where the call or call information is delivered to a given interface, such as a TDM or VoIP interface. For example, incoming calls or call information arrives from an interface as shown by arrows 1102 for routing, and the manipulated or routed call or call information is delivered to an interface as shown with arrows 1108. Test interface 1101 provides interface access to provide a test data structure to incoming call structure 1103 as shown with arrows 1104. The test data structure has the same organization as the data structure delivered over arrows 1102 from an incoming call or call information interface. Incoming call structure 1103 takes the input data structure, whether supplied through arrows 1102 or 1104, and applies them to router 1105. Router 1105 performs routing in accordance with the content of the data structure and rules or other information configured in router 1105 and outputs an outgoing data structure to outgoing call structure 1107. If the data structure applied to router 1105 is a test data structure, the test data structure is delivered to test interface 1101 and the results of operations conducted by router 1105 can be examined. If the data structure provided by router 1105 is not a test data structure, the data structure is provided to an outgoing interface indicated by arrows 1108. In one or more embodiments, the provision of a test data structure shown with arrows 1104, and the receipt of the resulting test data structure shown with arrows 1106 is achieved with a software function call that passes the test data structure to incoming call structure 1103, and the resulting test data structure provided by outgoing call structure 1107 is returned as the result of the function call. For example, a call may be made through an application programming interface (API) call to send and receive test data in a test data structure.

In one or more embodiments, a dial plan may be tested through a user interface such as the above-described test interface. For example, an interface may allow a user to test call routing and/or other rules for a desired call route and/or CPID information without receiving actual calls. The user interface may be presented as a real time simulation test interface. The test interface is a mechanism for validating and testing configurable items on the gateway (or any product with user configuration). The test interface consists of a user interface such as, for example, a web page or pages where the user can enter data that simulates real time data.

The test interface is not limited to applications involving a gateway or router, such as may involve testing of rules, routing table configuration or gateway operation. For example, different types of inputs and outputs other than TDM or VoIP calls may be accepted and produced. Examples of other types of inputs and outputs may include the following.
Tone detection—A user can configure the gateway or a tone detector for various tones to detect. The user may use the test interface to upload an audio file containing data which may include such tones, for example. The test interface applies the audio file to the gateway or tone detector and indicates tones that were detected.
CAS (Channel Associated Signaling) signaling—The user can be connected to a switch that uses non-standard CAS bit transitions for call control. The user can set up a custom configuration in the gateway to handle CAS signaling. The test interface can provide verification that the setup is correct, or otherwise test the custom configuration. The test interface can be used to simulate live calls using the CAS bit transitions to validate the custom configuration.

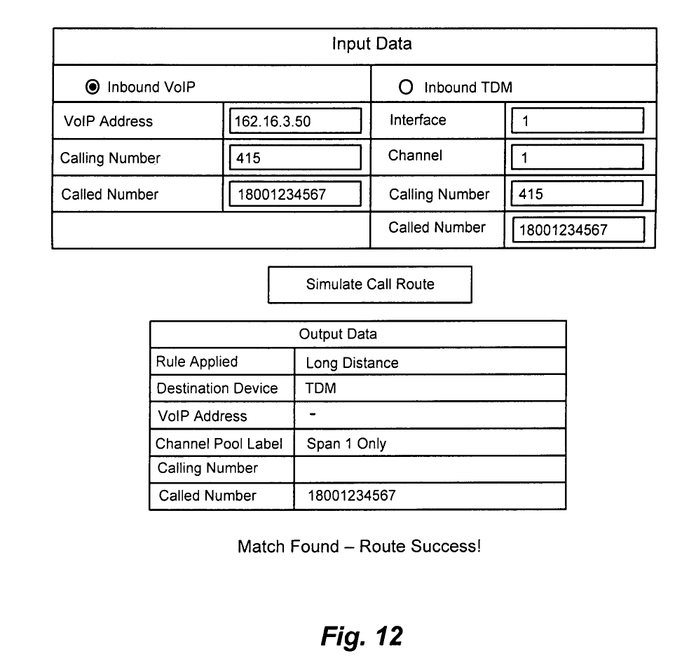

The specific implementation of the real time simulation test interface can vary for each type of test. The examples given above, and the discussion of the test interface for the dial plan, rules or routing table are just some of the examples of how the test interface may be used. In general, the test interface provides a mechanism to apply simulated data to validate a configuration, without operating on actual real time data, which would likely be disruptive to gateway operations. FIGS. 11 and 12 show an example “Test Dial Plan” interface that may be used in some implementations to test a dial plan, rule(s) or routing table configuration.

In some implementations, two tables may be presented in this interface, an input data table and an output data table. FIG. 11 shows an example test dial plan interface in which an inbound VoIP call is tested, and FIG. 12 shows an example test dial plan interface in which an inbound TDM call is tested. It should be recognized that these two interfaces and associated tables are given as examples only and that other implementations may include any arrangement for any interfaces. The “Input Data” table may be used to take simulated call characteristics from an incoming call. The call direction may be selected, and then the call information may be entered by a user into the table. The test call information may then be transmitted to/received by the gateway. The “Output Data” table may show the result (e.g., a representation of an action that the gateway has determined should be performed based on the dial plan and the test call information) that would occur if the simulated incoming call passed through the dial plan. Such functionality may be facilitated by performing a rule matching of the rules of the dial plan on the input data and outputting the result to the output data table rather than actually routing any calls or taking any other actions.

In some implementations, the input fields for simulated data may match the routing tables input fields. However, in some implementations, inbound TDM calls may accept the interface and channel instead of the channel pool label. This may help test the channel pool configuration as well as the routing configurations.

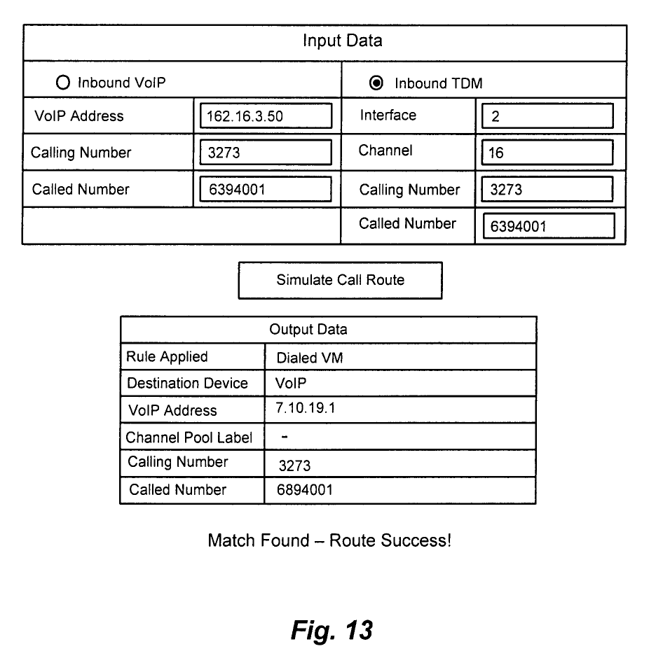

FIG. 13 shows an example scenario where a gateway may be used to route an incoming TDM call to a different VoIP endpoint based on the calling and called numbers.

In the example, an administrator of gateway 1200 may want callers from each area code from a public telephone network 1201 directed to a specific distributor 1205 on a VoIP network 1203. Each VoIP endpoint 1207 may have an agent assigned to an individual function. So, for example, if a customer from the Syracuse area wants to order cookies, the “cookies agent” at the Syracuse Distributor's VoIP address may receive the call.

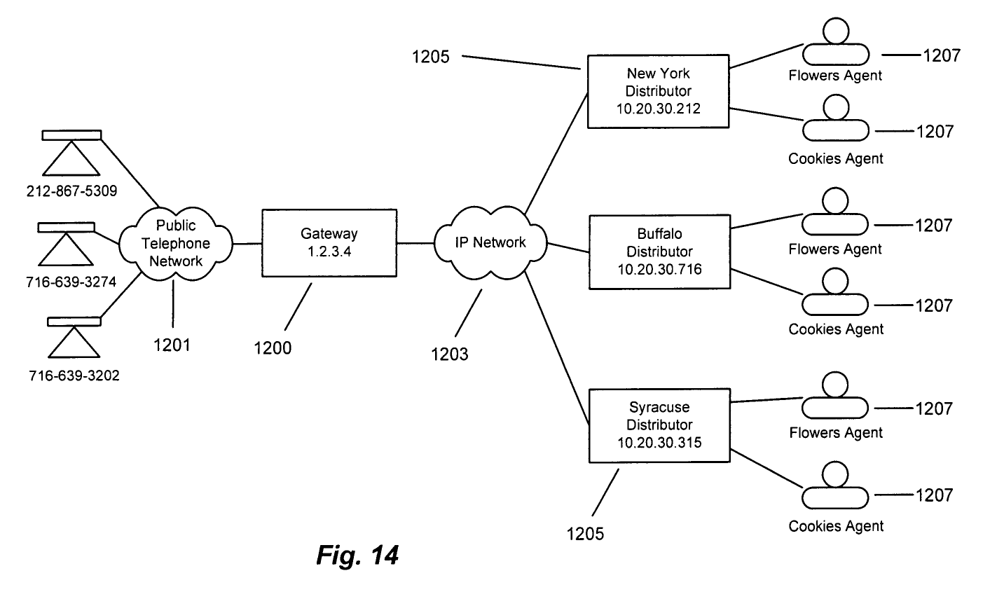

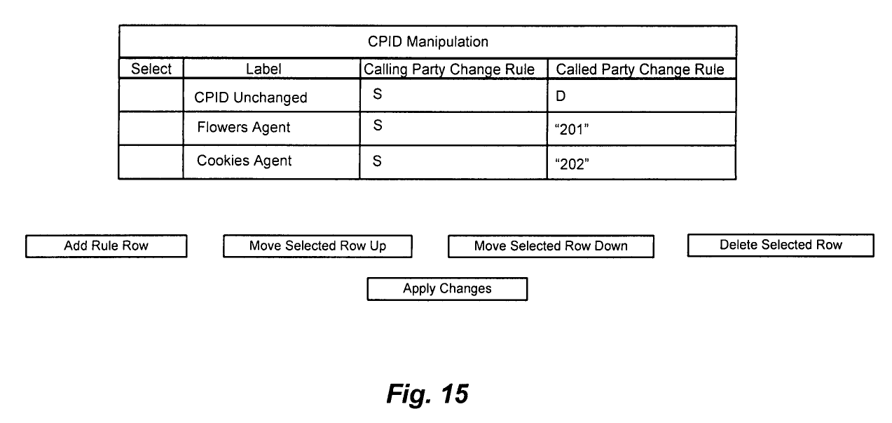

The implementation of such a gateway configuration may include table entries in the TDM to VoIP routing page, and the CPID manipulation page.
1. Example set up of the CPID manipulation rules. When the called number is 1-800-FLOWERS (18003569377), change the outgoing VoIP called number to the extension of the flowers agent, say 201. When the called number is 1-800-COOKIES (18002665437), change the outgoing VoIP called number to the extension of the cookies agent, say 202. FIG. 14 shows an example table with these entries.
2. Example set up of the TDM to VoIP routing rules. Calls from the 212 area code route to the New York Distributor. Calls from the 716 area code route to the Buffalo Distributor. Calls from the 315 area code route to the Syracuse Distributor. Compare the first 4 digits of the incoming calling number to determine the VoIP address of the distributor. FIG. 15 shows an example table with these entries.

The operations herein described are purely exemplary and imply no particular order. Further, the operations can be used in any sequence when appropriate and can be partially used. With the above embodiments in mind, it should be understood that the invention can employ various computer-implemented operations involving data stored in computer systems. These operations are those requiring physical manipulation of physical quantities. Usually, though not necessarily, these quantities take the form of electrical, magnetic, or optical signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The disclosed system and method can also be embodied as computer readable code on a computer readable medium. The computer readable medium is any data storage device that can store data, which can be thereafter be read by a computer system. Examples of the computer readable medium include hard drives, read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

The foregoing description has been directed to particular embodiments of this invention. It will be apparent, however, that other variations and modifications may be made to the described embodiments, with the attainment of some or all of their advantages. The procedures, processes and/or modules described herein may be implemented in hardware, software, embodied as a computer-readable medium having program instructions, firmware, or a combination thereof. For example, the function described herein may be performed by a processor executing program instructions out of a memory or other storage device. Therefore, it is the object of the appended claims to cover all such variations and modifications as come within the true spirit and scope of the invention.

What is claimed is:

1. A method of testing a dial plan, the method comprising:
providing a dial plan;
providing test call information;
determining at least one of an action to be performed or forwarding information for the test call information based, at least in part, on the dial plan; and
presenting a representation of the at least one of the action to be performed or the forwarding information for the test call information.

2. The method of claim 1, further comprising providing the representation through a user interface.

3. The method of claim 2, wherein the user interface includes at least one of a web-based user interface, windowed application-based interface or a console-based user interface.

4. The method of claim 1, wherein constructing the dial plan further comprises providing a set of rules that define at least one of:
when actions should be performed; and
how to route call information.

5. The method of claim 1, wherein providing the test call information further comprises providing at least one of source information or destination information.

6. The method of claim 5 further comprising determining the at least one of the action to be performed or forwarding information for the call information based, at least in part, on the dial plan and the at least one of the source information or the destination information.

7. The method of claim 1, further comprising providing a dial plan to determine the at least one of an action to be performed or forwarding information based on call type.

8. The method of claim 7, wherein the call type is one or more of a network call type comprising TDM or VoIP or a request call type comprising MWI or messaging.

9. A communication gateway configured to perform the method of claim 1.

10. A method of processing a call, the method comprising:
providing a set of rules for processing the call;
receiving a call having call information; and
determining at least one action from a plurality of available actions to perform in response to the call information based, at least in part, on the set of rules.

11. The method of claim 10, wherein the call information comprises at least one of source information or destination information.

12. The method of claim 11, further comprising determining the at least one action based, at least in part, on the set of rules and the at least one of the source information or the destination information.

13. The method of claim 10, wherein the plurality of available actions further comprise at least one of routing a call, blocking a call, logging at least a portion of the call information, raising an alarm, executing a desired program or notifying a desired entity.

14. The method of claim 10, further comprising providing a rule to determine the at least one action based on call type.

15. The method of claim 14, wherein the call type is one or more of a network call type comprising TDM or VoIP or a request call type comprising MWI or messaging.

16. A communication gateway configured to perform the method of claim 10.

17. A method of grouping communication channels, the method comprising:
receiving an indication of at least one channel of a first communication interface;
receiving an indication of at least one channel of a second communication interface; and
grouping the at least one channel of the first communication interface and the at least one channel of the second communication interface into a virtual channel pool.

18. The method of claim 17, further comprising:
providing at least one routing rule, the at least one routing rule identifying the virtual channel pool as a call routing destination;
receiving a call having call information matching the at least one routing rule; and
routing the call to the virtual channel pool.

19. The method of claim 18, wherein routing the call information to the virtual channel pool further comprises determining a one of the at least one channel of the first communication interface or the at least one channel of the second communication interface for routing the call, and routing the call to the one of the at least one channel of the first communication interface or the at least one channel of the second communication interface.

20. The method of claim 19, further comprising determining the one of the at least one channel of the first communication interface or the at least one channel of the second communication interface according to a desired selection mode.

21. The method of claim 20, further comprising providing at least one indication of a desired selection mode.

22. The method of claim 17, further comprising defining a VoIP host group as one of the at least one channel of the first communication interface or the at least one channel of the second communication interface.

23. A method of grouping communication paths provided in a gateway, the method comprising:
defining a virtual communication path group to have at least one common characteristic for each of the communication paths in the virtual communication path group;
including at least one communication path associated with a TDM interface in the virtual communication path group;
including at least one communication path associated with a VoIP interface in the virtual communication path group; and
wherein the communication paths included in the virtual communication path group exhibit the at least one common characteristic.

24. A communication gateway configured to perform the method of claim 17.

25. A method of manipulating call information, the method comprising:
providing a manipulation rule, the manipulation rule identifying a manipulation formula for call information;
receiving a representation of a call having call information;
manipulating call information of the call according to the manipulation rule; and
routing the call toward a destination of the call.

26. The method of claim 25, wherein the manipulation formula defines manipulation of non-leading digits of a number identified by the call information.

27. The method of claim 26, wherein the number includes at least one of a source identifier or a destination identifier.

28. The method of claim 25, further comprising defining, using the emancipation rule, an operation performed as an offset to a portion of a number identified by the call information.

29. The method of claim 25, wherein the manipulation formula operates on one or more of text or digits.

30. A communication gateway configured to perform the method of claim 25.

31. A computer-implemented method for editing a dial plan based on input from a user of a computer system, the computer system having a display, the method comprising:
presenting, to the user in the display of the computer system, a user interface;
displaying through the user interface a representation of a set of rules, the set of rules defining at least a portion of the dial plan;
accepting from the user an indication of an alteration to an execution of the set of rules; and
altering the set of rules to incorporate the alteration.

32. The method of claim 31, wherein the alteration includes at least one of an enabling of a respective rule of the set of rules, a disabling of a respective rule of the set of rules, or a change to an order of the set of rules.

33. The method of claim 31, wherein the user interface includes at least one of a web-based interface, windowed application-based interface or a console-based interface.

34. The method of claim 31, further comprising routing a call using the altered set of rules.

35. A computer-implemented method for editing a dial plan based on input from a user of a computer system, the computer system having a display, the method comprising acts of:
presenting, to the user, in the display of the computer system, a user interface;
accepting, from the user, an indication of a desired rule;
determining a validity of the desired rule; and
displaying, through the user interface, a representation of the validity of the desired rule.

36. The method of claim 35, further comprising performing determining and displaying in substantially real-time with respect to accepting.

37. The method of claim 35, wherein the representation includes a colored-coded indicator.

38. The method of claim 35, wherein the user interface includes at least one of a web-based interface, windowed application-based interface or a console-based interface.

39. The method of claim 34, wherein the act of determining includes determining if a syntax of the desired rule matches a recognized syntax.

40. A method of testing a communication network component using a test interface, the method comprising:
configuring the component with a behavior to be tested;
applying an input to the component through the test interface using a data structure; and
receiving an output of the component through the data structure, the output being generated by the component in accordance with the behavior and a content of the input data structure; and
presenting an indication of the output to the test interface.
